(19) United States
(12) Patent Application Publication
(10) Pub. No.: US 2016/0353235 A1
(43) Pub. Date: Dec. 1, 2016

(54) LOCATION-BASED ORDER RECOMMENDATIONS

(71) Applicant: Accenture Global Services Limited, Dublin (IE)

(72) Inventors: Thomas Williams, London (GB); Leona Seaward, Oxfordshire (GB); John Thirlaway, Gateshead /Tyne & Wear (GB); Jonathan Haynes, Tyne and Wear (GB)

(21) Appl. No.: 14/827,153

(22) Filed: Aug. 14, 2015

Related U.S. Application Data
(60) Provisional application No. 62/169,325, filed on Jun. 1, 2015.

(51) Int. Cl. H04W 4/02; H04W 4/14

(52) U.S. Cl. CPC H04W 4/02; H04W 4/14; G06Q 50/12

(57) ABSTRACT

In one implementation, a computer-implemented method includes receiving location information that identifies, at least, a current location of a mobile computing device that is associated with a user; accessing order history information for the user; identifying candidate providers based on the current location of the mobile computing device; determining one or more confidence values that indicate extents to which the user is likely to be interested in ordering one or more of food items from one or more of the candidate providers; selecting a food suggestion to be fulfilled by a particular candidate provider and provided to the user based, at least in part, on the one or more confidence values; and providing, to the mobile computing device, a notification of the food suggestion that suggests the user place an order with the particular candidate provider.

### CROSS-REFERENCE TO RELATED APPLICATIONS

This application claims the benefit under 35 U.S.C. §119(e) of U.S. Provisional Patent Application No. 62/169,325, entitled “LOCATION-BASED ORDER RECOMMENDATIONS,” filed Jun. 1, 2015. The disclosure of the foregoing application is incorporated herein by reference in its entirety for all purposes.

### TECHNICAL FIELD

This document generally describes technology related to computer-generated recommendations for electronic orders, such as orders for food items placed through mobile applications.

### BACKGROUND

Mobile computing devices (e.g., smartphones, tablet computing devices, wearable computing devices) have been programmed to assist users with placing orders for goods and services. For example, users can download and install mobile applications (“mobile apps”) for retailers, and can use the mobile apps to browse goods, select goods (e.g., place goods in an electronic shopping cart), purchase the selected goods (e.g., electronically checkout), designate a way for the user to get the goods (e.g., delivery, in-store pickup), and can track the progress of their orders (e.g., view order status).

Some mobile apps can include location-based services to provide users with information that is likely to be relevant the users' current locations. For example, a mobile app for a retailer with multiple physical stores can include location based services that allow a user to identify the closest store nearby for the retailer. For instance, a user of such a mobile app may select a feature to view the closest store nearby, and the mobile app can access the current location of the mobile computing device (that is running the mobile app), provide it to a location service for the retailer, and receive in response a listing of the stores for the retailer that are closest to the mobile computing device's current location.

### SUMMARY

This document generally describes generating and providing order recommendations to mobile computing devices based on a variety of factors, such as the location of the mobile computing device. Order recommendations can be determined and provided on mobile computing devices without users first initiating or otherwise requesting the order recommendations. For example, a user commuting to work in the morning can receive a notification (e.g., push notification) on his/her mobile computing device suggesting the user place an order for coffee at a coffee shop that is on the user's way to work. Such a notification can be determined for the user based on a variety of factors, such as the user's current location (e.g., location along his/her commute to work), the location of the coffee shop (e.g., located along the user's route), the time of day (e.g., morning), and/or the user's order history (e.g., frequently ordering coffee in the morning, frequently ordering from the coffee shop).

In one implementation, a computer-implemented method includes receiving, at a computer system, location information that identifies, at least, a current location of a mobile computing device that is associated with a user; accessing, by the computer system, order history information for the user, wherein the order history information identifies, at least, (i) previous food orders that were placed by the user, (ii) providers that fulfilled the previous orders, and (iii) items that were included in the previous orders; identifying, by the computer system, candidate providers based on the current location of the mobile computing device; determining, by the computer system, one or more confidence values that indicate extents to which the user is likely to be interested in ordering one or more of food items from one or more of the candidate providers, the one or more confidence values being determined based, at least in part, on (i) the current location of the mobile computing device, (ii) the order history information, and (iii) the candidate providers; selecting, by the computer system, a food suggestion to be fulfilled by a particular candidate provider and provided to the user based, at least in part, on the one or more confidence values; and providing, by the computer system and to the mobile computing device, a notification of the food suggestion that suggests the user place an order with the particular candidate provider.

Such a computer-implemented method can optionally include one or more of the following features. The computer-implemented method can further include receiving, at the computer system and from the mobile computing device, a request to place the order with the particular candidate provider in response to the notification; and initiating, by the computer system, fulfillment of the order by the particular candidate provider, wherein the initiating causes the order to be provided to the particular candidate provider. The computer-implemented method can further include providing, by the computer system and to the mobile computing device, another notification confirming that the order has been received and is being fulfilled by the particular candidate provider. The computer-implemented method can further include receiving, at the computer system, information indicating that the order has been fulfilled and is available for pickup at the particular candidate provider; and providing, by the computer system and to the mobile computing device, another notification indicating that the order has been fulfilled and is available for pickup at the particular candidate provider.

The location information can further identify a route along which the mobile computing device is travelling, and the computer-implemented method can further include determining, by the computer system, a destination location to which the mobile computing device is likely travelling based, at least in part, on the current location of the mobile computing device and the route. The candidate providers can additionally be identified as being located within a threshold distance of either the destination location or points along portions of the route that have not yet been reached by the mobile computing device. The location information can further identify a current elevation of the mobile computing device, and the candidate providers can be identified as being within a threshold distance of the mobile computing device at the current elevation and the current location.

The computer-implemented method can further include determining, by the computer system, a current time of day. The order history information can further identify previous times at which the previous orders that were placed by the user, and the one or more confidence values can be determined further based on a comparison of the current time of day and the previous times. The computer-implemented method can further include accessing, by the computer system, preference information that identifies one or more preferences for the user. The order history information can further include information that identifies whether the previous food orders are included in the one or more preferences, and the one or more confidence values can be determined further based on a comparison of the preference information and the previous food order. The computer-implemented method can further include identifying, by the computer system, one or more current external factors for the user. The order history information can further identify previous external factors when the previous orders that were placed by the user, and the one or more confidence values can be determined further based on a comparison of the current external factors and the previous external factors. The current external factors and the previous external factors can include one or more of: weather, traffic, the user's schedule, and the user's activity level as indicated by data collected from one or more activity tracking devices.

The computer-implemented method can further include identifying, by the computer system, a current speed at which the mobile computing device is travelling. The candidate providers can be further identified based on the current speed. The particular candidate provider can be one of the providers that fulfilled the previous orders. The particular candidate provider can be different from each of the providers that fulfilled the previous orders. The particular candidate provider can be part of a chain of providers, and one or more other providers that are also part of the chain of providers are included in the providers that fulfilled the previous orders. The order history information for the user can further identify previous orders that the user placed but did not pick up. The order history information for the user can further identify previously declined order suggestions that included notifications with order suggestions sent to the mobile computing device and declined by the user, and previously accepted order suggestions that included notifications with order suggestions sent to the mobile computing device and accepted by the user. The notification can be a push notification.

In another implementation, a computer-implemented method includes providing, by a mobile computing device and to a computer system, location information that identifies a current location of the mobile computing device; receiving, at the mobile computing device, a push notification that includes (i) a suggested order with the particular candidate provider and (ii) a selectable feature for placing the suggested order, wherein the particular candidate provider was identified based, at least in part, on the current location of the mobile computing device, wherein the push notification is not responsive to a request from the mobile computing device for an order suggestion related to the current location of the mobile computing device; outputting, by the mobile computing device, the push notification; receiving, at the mobile computing device, user input including a selection of the selectable feature for placing the suggested order; providing, by the mobile computing device and to the computer system, a request to place the suggested order in response to receiving the selection of the selectable feature; and receiving, at the mobile computing device, another notification that the order has been placed with the particular candidate provider.

Such a computer-implemented method can optionally include one or more of the following features. The computer-implemented method can further include determining, by the mobile computing device, the current location of the mobile computing device; and determining, by the mobile computing device, a current elevation of the mobile computing device. The location information can further identify the current elevation of the mobile computing device.

In another implementation, a computer system includes one or more interfaces that are programmed to receive location information that identifies current locations of mobile computing devices that are associated with users; a database that is programmed to store order history information for the users, wherein the order history information identifies, at least, (i) previous food orders that were placed by the users, (ii) providers that fulfilled the previous orders, and (iii) items that were included in the previous orders; a provider identification component that is programmed to identify candidate providers based on the current locations of the mobile computing devices; an order prediction module that is programmed to (i) determine one or more confidence values that indicate extents to which the users are likely to be interested in ordering one or more of food items from one or more of the candidate providers, and (ii) select food suggestions to be fulfilled by particular candidate providers to suggest to the users based, at least in part, on the one or more confidence values, wherein the one or more confidence values are determined based, at least in part, on (i) the current locations of the mobile computing devices, (ii) the order history information, and (iii) the candidate providers; and a messaging subsystem that is programmed to provide notifications to the mobile computing devices that suggest the users place orders with the particular candidate providers.

Certain implementations may provide one or more advantages. For example, orders can be suggested to users without the users requesting the suggestions. For example, a user busy getting ready for work may not think to place an advance order for a food item, such as coffee, with a nearby coffee shop. By suggesting orders to users in advance of the user's requesting the suggestions, users can be prompted to place orders at appropriate times to create more efficiencies and streamline their time.

In another example, by analyzing previous order and travel histories for users, order suggestions can be tailored so that they are provided when there is a high likelihood that they will be relevant. High confidence thresholds can be used to ensure that users are not flooded with order suggestions, but instead are provided with a discrete number of order suggestions at appropriate times and/or in unobtrusive manners.

The details of one or more embodiments are set forth in the accompanying drawings and the description below. Other features and advantages will be apparent from the description and drawings, and from the claims.

### DESCRIPTION OF DRAWINGS

FIGS. 1A-B are conceptual diagrams of an example system for providing order suggestions to mobile computing devices.

FIG. 2 depicts an example system for providing order suggestions to mobile computing devices.

FIGS. 3A-B are flowcharts of an example technique for providing order suggestions to mobile computing devices.

FIG. 4 is a flowchart of an example technique for receiving and processing order suggestions on a mobile computing device.

FIG. 5 is a block diagram of an example system for providing suggested orders.

FIG. 6 illustrates a schematic diagram of an exemplary generic computer system.

Like reference symbols in the various drawings indicate like elements.

### DETAILED DESCRIPTION

This document generally describes techniques, systems, program products, and computing devices for providing order recommendations to mobile computing devices, such as recommendations for food orders at restaurants (e.g., fast food restaurants, restaurant chains, dine-in restaurants, take-out restaurants, food delivery services). Order recommendations can be determined and provided based on a variety factors, such as location information for mobile computing devices, the proximity of nearby providers, previous orders, time and date information, external factors (e.g., weather, user schedule), and/or other appropriate factors.

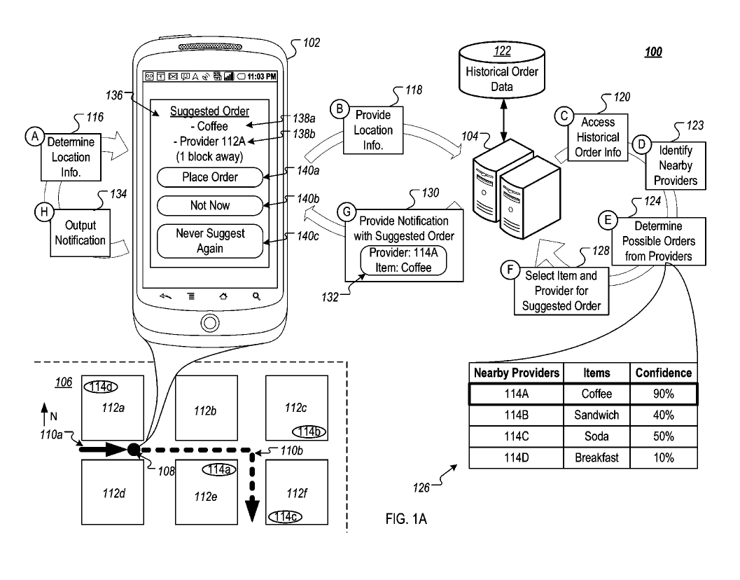

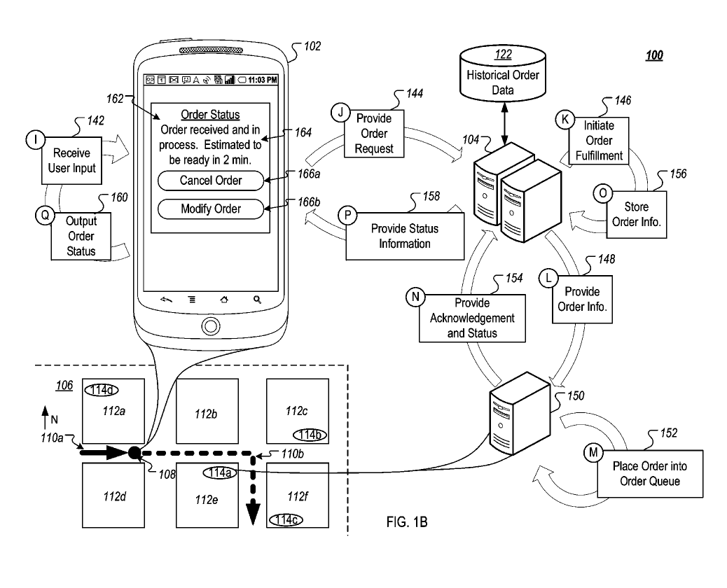

FIGS. 1A-B are conceptual diagrams of an example system 100 for providing order suggestions to mobile computing devices. The example system 100 includes an example mobile computing device 102 that can receive order suggestions from an example computer system 104.

The mobile computing device 102 can be any of a variety of appropriate mobile computing devices, such as smartphones, tablet computing devices, personal digital assistants (PDA), media players, laptops, wearable computing devices (e.g., GOOGLE GLASS, MICROSOFT HOLOLENS), navigational computing devices (e.g., automobile navigational systems), and/or other appropriate mobile computing devices. The computer system 104 can be any of a variety of appropriate computer systems, such as server systems, cloud-based computer systems, and/or any other appropriate collection of one or more computing devices. The mobile computing device 102 and the computer system 104 can communicate over one or more communication networks, such as the internet, wireless networks (e.g., Wi-Fi networks, mobile data networks), local area networks (LAN), wide area network (WAN), virtual private networks (VPN), or any combination thereof.

Referring to FIG. 1A, an example map 106 is depicted showing a current location 108 of the mobile computing device 102 as it travels along portions 110a-b of a route in an area with blocks 112a-f. The mobile computing device 102 is depicted as having already completed a first portion 110a of the route and intending to proceed along a second portion 110b of the route. Example providers 114a-d (e.g., restaurants, coffee shops, fast food chains, retailers) are depicted at various locations in the blocks 112a-f. For instance, the provider 114a is depicted as being located in the NE corner of block 112e, the provider 114b is depicted as being located in the SE corner of block 112c, the provider 114c is depicted as being located in the SW corner of block 112f, and the provider 114d is depicted as being located in the NW corner of block 112a.

As indicated by example step A (116), the mobile computing device 102 can determine its geographic location information, which can include information that identifies the current location 108 of the mobile computing device 102. The mobile computing device 102 can use any of a variety of appropriate techniques to determine its geographic location, such as GPS techniques, Wi-Fi signals, cellular triangulation, beacon signals, user input, or any combination thereof. The location information that is determined by the mobile computing device 102 can be any of a variety of information that can, with at least a minimum level of granularity, identify the location 108, such as GPS coordinates, the identities of nearby computing devices (e.g., Wi-Fi routers, cell towers), and/or a physical address of the location 108 (e.g., street address, zip code, city).

In some implementations, the location 108 of the mobile computing device 102 is determined by a system that is remote from the mobile computing device 102, such as a data or cellular network provider that is able to triangulate the location 108 through the use of a grid of transceivers located near or around the location 108.

The mobile computing device 102 can provide the location information to the computer system 104, as indicated by step B (118). The mobile computing device 102 can provide the location information periodically (e.g., every minute, every 5 minutes, every 15 minutes, whenever the location changes by more than a threshold amount) to the computer system 104 and without explicit direction from a user of the mobile computing device 102, such as part of a background process/service running on the mobile computing device 102. The mobile computing device 102 may verify that a user of the mobile computing device 102 has previously consented the mobile computing device 102 periodically sharing the location information with the computer system 104 so as to protect the user's privacy.

In response to receiving the location information, the mobile computing device 102 can access historical order information for the user and/or the mobile computing device 102, as indicated by step C (120). The computer system 104 can access one or more historical data sources, which may be locally maintained by the computer system 104 and/or remotely accessed by the computer system 104. For example, the computer system 104 can maintain a local data repository 122 of historical order data for the user of the mobile computing device 102, such as records of orders processed by the computer system 104 and/or affiliates/partners of the computer system 104, and/or records of orders provided by the mobile computing device 102 to the computer system 104. However, this may be an incomplete picture of the orders placed by the user and/or the mobile computing device 102. Other third party sources of historical order information for the user and/or the mobile computing device 102 can be accessed by the computer system 104, such as records for customer loyalty programs, credit card records, and/or other appropriate sources of order information. A user of the mobile computing device 102 may authorize some or all of the order records being stored and/or accessed by the computer system 104.

The historical order information can include a variety of details regarding previous orders by the user and/or the mobile computing device 102, such as providers at which the orders were made (e.g., provider name, provider location, provider type, provider affiliation with chains and/or other providers), items that were ordered (e.g., types of items, particular food items ordered, particular consumer goods ordered), time and date information on which the orders were made (e.g., time of day, day of the week, date), manners in which the order was fulfilled (e.g., pickup, delivery), how the user initiated the order (e.g., in-person order, order using the mobile computing device 102, order initiated from order suggestion by the computer system 104), and/or other appropriate details.

The computer system 104 can access the historical order information to determine behavior patterns and preferences for the user of the mobile computing device 102, which can be used to determine whether, when, and/or what type of order suggestion to provide to the user. For example, the historical order information can be used to determine that the user of the mobile computing device 102 has a 75% likelihood of getting coffee from a coffee shop in his/her way into work on Mondays and Wednesdays. A variety of techniques can be used to glean such patterns and user preferences, such as processing the historical order information using machine learning algorithms (e.g., neural networks, clustering, regressions).

The computer system 104 can identify providers that are located near the location 108 of the mobile computing device 102 and/or locations along the route 110a-b of the mobile computing device 102, as indicated by step D (123). The computer system 104 can access a repository of provider information, which can include location information for the providers. For mobile providers, such as food truck providers that are in different locations each day, the provider information can be updated dynamically based on data feeds for providers, such as TWITTER feeds for food truck vendors. Distances (e.g., absolute, distances along roads) between the location 108 of the mobile computing device 102 (and/or locations along the route 110a-b, including starting locations and/or end locations) and the providers can be determined by the computer system 104, and providers that are within a threshold distance of one or more of these locations can be selected.

Although not depicted, the computer system 104 can also maintain information on historical routes that are traveled by the user and/or the mobile computing device 102, and can use that information to determine patterns of travel behavior for the user to predict the second portion 110b of the route that is yet to be traveled by the mobile computing device 102. The historical route information can be maintained by the computer system 104, the mobile computing device 102, and/or other third party services that the user of the mobile computing device 102 has consented to. For example, the computer system 104 can determine that on weekdays (M-F) the user typically travels from his/her home to work along a particular route between 8:00 am-8:30 am. The computer system 104 can use any of a variety of appropriate techniques to detect such travel patterns, such as processing the historical route information using machine learning algorithms (e.g., neural networks, clustering, regressions).

In the depicted example, the computer system 104 can identify the providers 114a-d as being nearby and can designate them as candidate providers for a possible order suggestion to be provided to the mobile computing device 102.

The computer system 104 can use the historical order information and the nearby (candidate) providers to determine possible orders to suggest to the user of the mobile computing device 102, as indicated by step E (124). For example, the computer system 104 can identify items that are offered by the providers 114a-d that the user may be interested in ordering based on a variety of factors, such as the historical order information and/or other appropriate factors (e.g., location 108, time of day, route 110a-b, provider preference, item preference, external factors like weather). The computer system 104 can determine confidence values for each of the candidate orders based on such factors. A candidate order with high confidence value can indicate a high likelihood that the user will be interested in placing the order, whereas a candidate order with a low confidence value can indicate a low likelihood that the order will be placed. In general, orders with high confidence values correlate closely with previous orders placed by the user and/or the mobile computing device 102 along one or more dimensions (e.g., location, time of day, item ordered, route, provider identity).

A table 126 is depicted showing example results from such determination of candidate orders by the computer system 104. In the table 126, the computer system 104 identifies a first example candidate order to suggest to the computing device 102 as including coffee fulfilled by the provider 114a, a second example candidate order including a sandwich fulfilled by the provider 114b, a third example candidate order including a soda fulfilled by the provider 114c, and a fourth example candidate order including breakfast fulfilled by the provider 114d. The computer system 104 in this example determines the first example candidate order as having the highest confidence value (90%) based, for example, on the provider 114a being located along the portion 110b of the route that the user has not yet completed, the provider 114a being a provider that the user has ordered from previously, and the item that is available at the provider 114a being something that the user is likely to be interested in presently ordering. The confidence value for the second and third candidate orders with providers 114b-c are determined to be mid-level confidence values (40% and 50%, respectively) that can be based on, for example, the providers 114b-c being located along or near the portion 110b of the route, but the food items (sandwich and soda) and/or providers 114b-c not matching well with the user's likely preferences within the present context (e.g., time of day, day of week, location 108, route 110a-b, external factors, provider identity/type). The confidence value for the fourth candidate order with the provider 114d is determined to be the lowest based, for example, on the provider 114d being located along/near the completed portion 110a of the route—meaning that the user would have to backtrack to go to the provider 114a, which would likely be undesirable.

Although the examples described above include a single item for each candidate provider, other implementations in which multiple items are considered for each candidate provider are also possible. Similarly, other implementations in which no particular items are considered for suggested orders with the candidate providers are also possible.

The computer system 104 can select a particular candidate order (e.g., provider, provider and item, item) to suggest to the mobile computing device 102, as indicated by step F (128). Such a selection can be based, at least in part, on the confidence values determined by the computer system 104. For example, the computer system 104 can select the candidate order for provider 114a.

As indicated by step G (130), the computer system 104 can generate a notification 132 for the suggested order to the mobile computing device 102. In this example, the notification 132 includes information identifying the provider 114a and the food item (coffee). The notification 132 can be any of a variety of appropriate notifications, such as push notifications, text messages, email messages, social network messages, social network posts, voice messages, video messages, and/or other appropriate messages. Although the example here uses food items (e.g., food, beverages) as examples, the system 100 can be applied to other items (e.g., clothing, consumer goods) and with regard to other providers (e.g., retailers).

The timing for delivery of the notification 132 can be considered by the computer system 104 relative to a variety of factors, such as the estimated time for the provider 114a to prepare the items so that it is available to the user when he/she arrives at the provider 114a, the distance between the current location 108 of the device 102 and the provider 114a's location, and/or factors that may affect the user's arrival at the provider 114a's location (e.g., traffic, inclement weather, available parking, transit schedules and delays). For example, the computer system 104 can deliver the notification 132 to the mobile computing device 102 so that the item can be made available within a window of time in which the user would be expected to arrive at the provider 114a.

The mobile computing device 102 can receive the notification 132 with the suggested order and can output the notification 132, as indicated by step H (134). The notification 132 can be output in any of a variety of appropriate ways, such as visually/graphically on a display of the device 102 and/or audibly through speakers accessible to the device 102. An example user interface 136 outputting the notification 132 is depicted. In the example interface 136, suggested order information 138a-b identifying the suggested food item (138a) and the suggested provider (138b) is output, and selectable features 140a-c for the user to initiate actions with regard to the suggested order are output. For instance, the user can select a first selectable feature 140a to place the suggested order, a second selectable feature 140b to indicate that the suggested order was helpful but that the user is not currently interested, and a third selectable feature 140c to indicate that the suggested order (and/or similar suggested orders) should never again be provided on the mobile computing device 102.

Referring to FIG. 1B, example input for the feature 140a (place order selectable feature) is received by the mobile computing device 102 indicating that the user desires that the suggested order be placed with the provider 114a, as indicated by step I (142). In response to receiving the input, the mobile computing device 102 can provide an order request to the computer system 104, as indicated by step J (144). The order request can specify the suggested provider 114a and/or the suggested item. The user may be able to deviate from/modify the suggested order using the interface 136, such as switching the suggested order from coffee to tea.

The computer system 104 can receive the order and initiate fulfilment, as indicated by step K (146). Fulfilment can include processing payment information for the order and/or transmitting the information on the order to a computer system that is associated with the provider 114a. For example, the computer system 104 can provide information for the order to a provider computer system 150 that is associated with the provider 114a, as indicated by step L (148). The provider computer system 150 can manage a variety of details for the provider 114a, such as order processing, inventory management, staffing, payment processing, point of sale terminals, and/or other appropriate features. The provider computer system 150 can enter the order into an order queue for fulfilment by the provider 114a, as indicated by step M (152), and can provide acknowledgement and status information for the order to the computer system 104, as indicated by step N (154). The provider computer system 150 can periodically provide status updates on the order to the computer system 104, such as every 30 seconds, every minute, and/or every time the fulfilment process progresses to a new stage of fulfillment (e.g., building pizza, putting pizza in oven, baking, ready for pickup).

The computer system 104 can receive the status acknowledgement and status information, and can store information about the order in the historical order data repository 122, as indicated by step O (156). These order records can be used to suggest future orders to the user and/or the mobile computing device 102.

The computer system 104 can provide status information on the order's fulfillment to the mobile computing device 102, as indicated by step P (158). The mobile computing device 102 can receive and output the order status information, as indicated by step Q (160). For instance, the mobile computing device 102 can output the example user interface 162 that includes information 164 on the status of the order (e.g., acknowledgement that fulfillment has begun, estimated time order will be ready) and selectable features 166a-b for the user to cancel the order (166a) and/or to further modify the order 166b. Selection of either of the features 166a-b can cause the computing device 102 to send updates to the order (cancel, modify) to the computer system 104, which can store the updates in the data repository 122 and can rely the updates to the provider computer system 150.

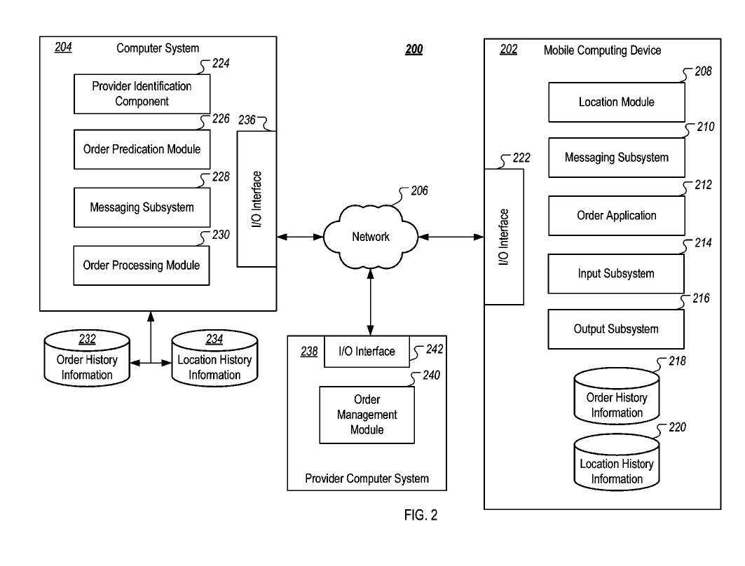

FIG. 2 depicts an example system 200 for providing order suggestions to mobile computing devices. The example system 200 can be similar to the system 100 described above with regard to FIGS. 1A-B. The system 200 includes a mobile computing device 202 that receives order suggestions from a computer system 204 over a communications network 206. The mobile computing device 202 and/or the computer system 204 can be similar to the computer system 104.

The mobile computing device 202 can be similar to the mobile computing device 102 and can be any of a variety of appropriate mobile computing devices, such as a smartphone, a tablet computing device, and/or wearable computing device. The mobile computing device 202 includes a location module 208 that is programmed to determine a current location for the mobile computing device 202. The location module 208 can include and/or access components, such as GPS and/or Wi-Fi components. Locations identified by the location module 208 can be transmitted to the computer system 204 and can be used by the computer system 204 to determine whether to provide order suggestions to the mobile computing device 202.

The mobile computing device 202 also includes a messaging subsystem 210 that can be programmed to send, receive, output, and/or create messages on the mobile computing device 202. For instance, the messaging subsystem 210 can be text messaging application and/or a push notification subsystem that are running on the mobile computing device 202.

The mobile computing device 202 can additionally include an order application 212 that is programmed to manage suggested and/or placed orders on the mobile computing device 202. For example, the order application 212 can be, for instance, a mobile app that is programmed to obtain be launched when notifications with suggested orders are received, to output user interfaces on the mobile computing device 202 for a user to view and select responses to the suggested orders, and to transmit order information to the computer system 204. The order application 212 can use an input subsystem 214 and an output subsystem 216 that are part of the mobile computing device 202 to output suggested order (and placed order) information, and to receive user input. The input subsystem 214 can include any of a variety of components through which a user can provide input, such as touchscreens, keyboards, physical buttons, cameras, microphones, accelerometers, gyroscopes, magnetometers, and/or other appropriate input devices. The output subsystem 216 can include any of a variety of components through which a user can provide output, such as displays, speakers, haptic feedback devices, and/or other appropriate output devices.

The mobile computing device 202 can locally store information that may be used to provide suggested orders, such as historical order information 218 and/or location history information 220. The historical order information 218 can be a log of orders that were placed using the order application 212, other applications, and/or orders that were placed by a user without use of the mobile computing device 202 (e.g., orders placed in person at a provider location, orders placed by phone and/or text message). The location history information 220 can be a log of locations that the mobile computing device 202 has been, including information that can be used to determine routes that the mobile computing device 202 has traveled. With the user's consent, the information 218 and/or 202 can be provided to and used by the computer system 204.

The mobile computing device 202 includes an input/output (I/O) interface 222 that is configured to transmit and receive information over the network 206. The I/O interface 222 can be any of a variety of appropriate interfaces, such as wired and/or wireless communication interfaces. The network 206 can be any of a variety appropriate communication networks, such as the internet, wireless networks, wired networks, or any combination thereof.

The computer system 204 includes a provider identification component 224 that is programmed to identify candidate providers for suggested orders for the mobile computing device 202. For example, the provider identification component 224 can use the location information determined by the location module 208, historical travel information for the mobile computing device 202, and/or provider location information to identify candidate providers to suggest to the mobile computing device 202.

The computer system 204 additionally includes an order prediction module 226 that is programmed to determine orders to suggest to the user based on confidence values/scores for candidate orders. The order prediction module 226 can use candidate providers identified by the provider identification component 224 to identify orders that may be of interest to a user of the mobile computing device 202. The order prediction module 226 can make such determinations based on a variety of factors, as discussed above with regard to FIG. 1A. For instance, the order prediction module 226 can use order history information 232 and/or location history information 234 for the mobile computing device 202 and its user to identify providers and candidate items that closely match one or more dimensions of a current context for the mobile computing device 202 and/or the user of the mobile computing device 202, such as the location and/or route of the mobile computing device 202, previous orders that were placed by the mobile computing device 202 (e.g., providers, item ordered, provider type), time and date information (e.g., time of day, day of the week, time of year), and/or external factors (e.g., current weather, traffic).

The computer system 204 additionally includes a messaging subsystem 228 through which the computer system 204 can transmit notifications for suggested orders. The messaging subsystem 228 can include any of a variety of appropriate messaging systems, such as text messaging platforms, push notification platforms, and/or other appropriate messaging platforms. The computer system 204 can further include an order processing module 230 that can process orders that are placed by the mobile computing device 202, such as suggested orders that the user of the mobile computing device 202 decides to place.

The order history information 232 and location history information 234 can be included in databases (and/or other data storage systems) that are maintained and/or accessible to the computer system 204. For example, the order history information 232 can include information that is stored as part of the computer system 204 and can also include information that is stored by a third party that provides the computer system 204 with access to the information.

The computer system 204 also includes an I/O interface 236 that transmit and receive information over the network 206.

The system 200 can additionally include a provider computer system 238 that can be similar to the provider computer system 150. The provider computer system 238 includes an order management module 240 that is programmed to receive orders, manage the fulfilment of orders (e.g., place in appropriate queues for completion of the order), and communicate status information regarding the orders. The provider computer system additionally includes an I/O interface 242 that can be similar to the I/O interfaces 222 and 236.

Although one of each of the entities 202, 204, and 238 is described, the system 200 can include multiples of each of the entities 202, 204, and 238. Additionally, the modules and components described for the entities 202, 204, and 238 can be implemented in any of a variety of ways, such as through software (e.g., applications, operating system process), hardware (e.g., application specific integrated circuit (ASIC)), firmware, or any combination thereof.

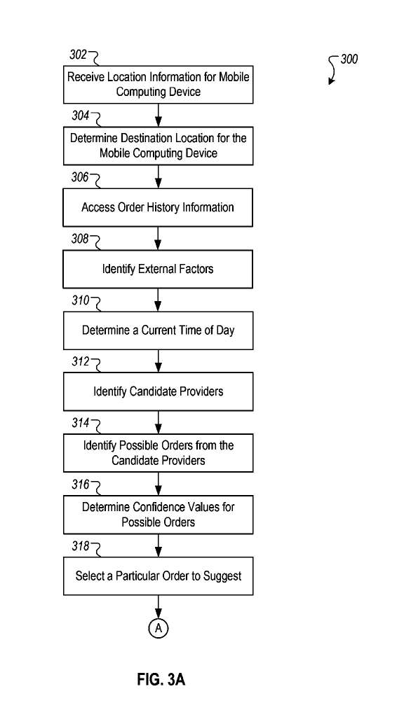

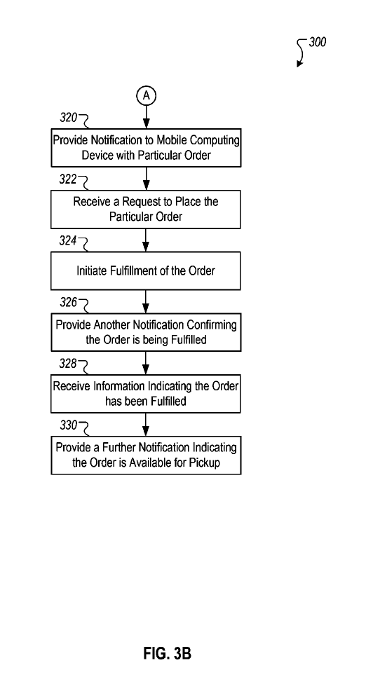

FIGS. 3A-B are flowcharts of an example technique 300 for providing order suggestions to mobile computing devices. The example technique 300 can be performed by any of a variety of appropriate computer systems and/or computing devices, such as the computer system 104 and/or the computer system 204. In some implementations, the example technique 300 may additionally be performed locally by a mobile computing device, such as the mobile computing devices 102 and/or 202.

Location information can be received for a mobile computing device (302). For example, the location information can be received by the computer system 204 and can include a variety of details regarding the mobile computing device 202, such as the current location of the mobile computing device 202, a direction/heading for the mobile computing device 202, a rate of speed at which the mobile computing device 202 is travelling, other devices and/or structures that are located nearby the mobile computing device 202, and/or an elevation of the mobile computing device 202 (e.g., floor, distance above or below ground).

One or more starting locations, destination locations, and/or routes along which the user is travelling or is likely to be travelling within a threshold period of time (e.g., within 5 minutes, 10 minutes, 15 minutes) can be determined based, at least in part, on the received location information and/or historical location information for the mobile computing device (304). For example, the provider identification component 224 of the computer system 204 can identify patterns of movement for the mobile computing device 202 and can compare the patterns to a current context for the mobile computing device 224, which can include the location information (e.g., current location, elevation, direction, speed), the time of day (e.g., morning, afternoon, evening, night), the day of the week (e.g., weekday vs. weekend day), the time of year (e.g., fall, winter, spring, summer), traffic conditions, and/or other appropriate factors. The provider identification component 224 can determine the strength of patterns to determine how well they will indicate future behavior of the user of the mobile computing device 202. For instance, the strength of patterns can be based on the frequency with which the behavior was observed, the frequency with which the user did not adhere to the pattern in spite of the same or similar context existing for the user, and/or how recently the user adhered to the pattern. The provider identification component 224 can use the strength values to determine confidence levels for starting locations, destination locations, and/or routes that are determined for the user and the mobile computing device 202 based on patterns matching (with at least a threshold level of similarity) the current context for the mobile computing device 202.

For example, assume that the provider identification component 224 identifies a strong pattern for the mobile computing device 202 that include travelling along a subway route on weekday mornings (with little deviation in behavior on weekday mornings), which can be indicated by the mobile computing device 202 travelling between locations along the subway route and being at a below ground elevation. The provider identification component 224 can use this pattern (detected from, for example, historical location information) to determine, with a high level of confidence, a destination location and route for the mobile computing device 202 when it is detected to be at a location along the subway route and at an elevation below ground.

Locations and routes can be determined with a variety of scales of granularity. For example, the provider identification component 224 may determine locations and routes within a matter of feet or meters, city blocks, neighborhoods, cities, and/or other appropriate levels of granularity. The provider identification component 224 can use zones (e.g., bounded geographic areas) to approximate the location and movements of the mobile computing device 202.

Order history information for the user can be accessed (306). For example, the order prediction module 226 can access information from the order history information data source 232 and/or can receive order history information from the local order history information 218 on the mobile computing device 202. The order history information can be used by the order prediction module 226 to identify candidate providers and orders that, given the current context for the mobile computing device 202 (e.g., location, time of day), the user of the mobile computing device 202 has at least a threshold likelihood of being interested in and placing.

The order prediction module 226 can use the order history information to identify order patterns and the strength of those detected patterns, using similar techniques to those described above with regard to determining starting locations, destination locations, and/or routes. For instance, the order prediction module 226 can use the order history to determine order patterns based on a variety of factors, such as the time and date information for orders (e.g., time of day, day of week, time of year), providers with which the orders were placed, provider locations, provider types (e.g., coffee shop, retail, fast food, sit-down restaurant), items that were ordered (e.g., specific food menu items, particular clothing items), types of items that were ordered (e.g., food, clothing), and/or other appropriate factors. The order prediction module 226 can also determine strengths of order patterns to determine how well they will indicate future order behavior of the user of the mobile computing device 202. For instance, the strength of order patterns can be based on the frequency with which the order behavior was observed, the frequency with which the user did not adhere to the order pattern in spite of the same or similar context existing for the user, and/or how recently the user adhered to the order pattern. The order prediction module 224 can use the strength values to determine confidence levels for suggested orders that are determined for the user and the mobile computing device 202 based on order patterns matching (with at least a threshold level of similarity) the current context for the mobile computing device 202.

The order patterns detected by the order prediction module 226 can have varying levels of detail and can be abstracted/generalized with regard to one or more dimensions of the patterns. Order patterns can be determined to associate specific and/or generic order dimensions. For example, the order prediction module 226 may determine that the user of the mobile computing device 202 has a pattern of ordering coffee (example specific food item) from coffee shops (generic provider type) between 8:00 am-8:30 am (example specific time window) regardless of the specific provider that is used (orders placed across many different providers). In another example, the order prediction module 226 may determine that the user has a pattern of ordering food items (generic item type) from a particular restaurant (example specific provider) on Fridays (example specific day of the week). In another example, the order prediction module 226 can determine that the user has a pattern of ordering pizza (example specific food item) from a chain of pizza restaurants (example specific provider group).

External factors for the user and/or the mobile computing device can be identified (308). External factors can include anything that could potentially influence the user's behavior, such as events going on around or near the mobile computing device (e.g., traffic, weather events) and/or things going on in the user's professional and/or personal life (e.g., events, schedule, exercise, entertainment). External factors can be determined in any of a variety of appropriate ways, such as through accessing information services (e.g., weather information, traffic information, social network services) from third party computer systems and/or obtaining information from a user's mobile computing device. For example, the computer system 204 can determine external factors for the mobile computing device 202 by accessing information from third party systems and/or obtaining information from the mobile computing device 202, which may obtain the information from communication with third party systems (e.g., social network computer systems, email systems, calendar systems), user input, and/or communication with peripheral devices (e.g., fitness tracker computing devices). Consent form a user of the mobile computing device 202 may be needed before the computer system 204 is provided with or access to any personal information for the user.

Current time and date information can be determined (310). For example, the computer system 204 can determine a current time of day, day of the week, month, time of year (e.g., season), and/or other appropriate information related to the current time or date.

Candidate providers can be identified based on any of a variety of factors, such as the location information, the determined likely destination location and/or route of travel, the order history information, external factors, and/or time/date information (312). For example, the provider identification component 224 can apply information indicating the current context of the mobile computing device 202 (e.g., location information, external factors, time/date information) to the behavior patterns for the user and the mobile computing device 202, such as the travel patterns and order patterns, to identify candidate providers with which the user may have at least a threshold likelihood of placing an order within a threshold period of time (e.g., within the next 5 minutes, 10 minutes, hour, day).

For instance, the provider identification component 224 can initially identify providers based on the travel patterns for the user by identifying providers that are located within a threshold distance of one or more of: the current location of the mobile computing device 202, a starting location for the mobile computing device 202, a destination location for the mobile computing device 202, and locations along one or more routes from the starting location to the destination location. The provider identification component 224 can cull this set of providers to a group of candidate providers based on order patterns. For example, if the user has a pattern of ordering coffee on weekday mornings from a particular chain of coffee shops and the current time/date information indicates that it is a weekday morning, the provider identification component 224 can reduce the set of candidate providers to those that are part of the particular chain of coffee shops.

Possible orders from the candidate providers can be identified for the user (314). For example, the order prediction module 226 can compare information about items provided at the candidate providers (e.g., menu of food items, product listing) with the order patterns (and contextual information for the mobile computing device 202) to identify one or more possible items to include in a suggested order to the mobile computing device 202. For example, if the order patterns determined by the computer system 204 indicate that within the current context (e.g., weekday morning) the user typically orders coffee, the order prediction module 226 can identify possible orders with candidate providers who offer coffee on their menus. Candidate orders may include information providers and/or items to be included with the suggested order.

Confidence values can be determined for the candidate providers and/or the candidate orders (316). For example, the order prediction module 226 can score candidate providers and/or candidate orders based on the likelihood that the user of the mobile computing device 202 will be interested in placing the suggested order. The confidence values can be based, at least in part, on the strengths for corresponding behavior patterns that were used to identify the candidate providers and/or candidate orders. The confidence values can additionally/alternatively be based, at least in part, on how closely a current context for the mobile computing device matches the behavior patterns. For example, the computer system 204 can determine a high confidence value for a candidate order that was derived from an order pattern that the user has closely adhered to (e.g., pattern of frequent orders by the user) and that the mobile computing device 202 closely matching the order pattern (e.g., location and time of day match with pattern).

A particular order can be selected from among the candidate orders to provide to the user of the mobile computing device (318). For example, the order prediction module 228 can rank the candidate orders based on their determined confidence values/scores and can select one or more of the orders having the greatest confidence values/scores to provide to the mobile computing device 202.

In some implementations, the order prediction module 228 can override and/or modify a ranking of candidate orders based on confidence values/scores. For example, the order prediction module 228 may override/modify the rankings when there is a strong correlations between one or more details of a candidate order and a current context for the mobile computing device 202, such as the mobile computing device 202 being located at a particular location. For instance, the order prediction module 228 can select a candidate order based on the current location of the mobile computing device 202 being a particular location that has a high correlation with a particular provider and/or a particular item in spite of other factors, such as the time of day, indicating that the candidate order may not be the best order to suggest to the user.

In some implementations, the order prediction module 228 can override and/or modify the rankings for candidate orders based on previous responses from the user of the mobile computing device 202 (and/or other users of other mobile computing devices). For example, the order prediction module 228 can increase the ranking of a candidate order that has been previously suggested on the mobile computing device 202 and that the user accepted (placed the suggested order). In another example, the order prediction module 228 can decrease the ranking of previously provided candidate orders that the user of the mobile computing device 202 ignored or otherwise dismissed.

In some implementations, the order prediction module 228 can override and/or modify the rankings of candidate orders based on incentives and/or promotions that are being offered by candidate providers. For example, a provider may be willing to offer significant discounts to users who, based on their order history, have never or infrequently visited the provider's location. Such incentivized discounts can be of interest to users, who would be more willing to deviate from their behavior pattern for a significant discount. The order prediction module 228 can take into account such incentive/promotional offers and can adjust the rankings for candidate offers (increase the rankings) based on the associated inventive/promotion. For instance, a greater discount on items that are of interest to the user can increase the ranking of a candidate order more than a smaller discount on items that are not likely to be of interest to the user. Similarly, discounts from providers that are located near the current location, destination location, starting location, and/or locations along a route for the mobile computing device 202 can increase the rankings of candidate orders more than discounts from providers that are located further away from one or more of those locations. The order prediction module 226 may also take into account previous user behavior (e.g., placed order, ignored order suggestion) in response to such promotions/incentives being provided as suggested orders.

Referring to FIG. 3B, a notification can be provided to the mobile computing device with the particular order that was selected (320). For example, the messaging subsystem 228 of the computer system 204 can transmit the selected order to the mobile computing device 202 over the network 206. The message can be transmitted in any of a variety of ways, such as push notifications, emails, text messages, voice messages, and/or other appropriate formats.

A request to place the particular order can be received from the mobile computing device (322), which can cause fulfillment of the order to be initiated (324). For example, the order processing module 230 of the computer system 204 can receive the request for the order to be placed and can initiate the order by transmitting information for the order to the provider computer system 238. The order processing module 230 can receive an acknowledgement of the order and status information from the provider computer system 238, and can provide another notification to the mobile computing device 202 indicating that the order is in the process of being fulfilled (326). The other notification can include information indicating, for example, a status of the order and an estimated time when the order will be ready.

Information can be received indicating that the order has been fulfilled (328). For example, the order processing module 230 can receive information from the order management module 240 of the provider computer system 238 indicating that the order is ready. In response to receiving the information, a further notification can be provided to the mobile computing device indicating that the order is available (330). For example, the order processing module 230 can use the messaging subsystem 228 to transmit another message to the mobile computing device 202 indicating that the order is available, for instance, for pickup.

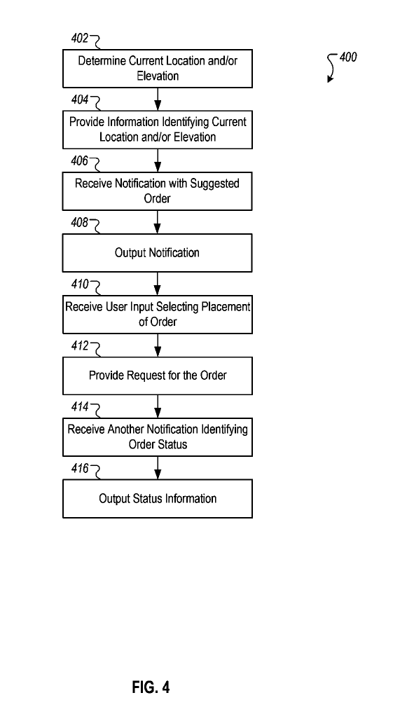

FIG. 4 is a flowchart of an example technique 400 for receiving and processing order suggestions on a mobile computing device. The example technique 400 can be performed by any of a variety of appropriate mobile computing devices, such as the mobile computing device 102 and/or the mobile computing device 202.

A determination can be made of the current location and/or elevation of a mobile computing device (402). For example, the location module 208 can determine a variety of details regarding the location of the mobile computing device 202, such as the current location, the direction/heading, and/or speed. The location module 208 can additional determine an elevation of the mobile computing device 202, such as through the use of short and medium range wireless signals (e.g., Wi-Fi signals, BLUETOOTH signals) that are detected by the computing device 202.

Information identifying the current location (and other location and elevation details) can be provided to a computer system (404). For example, the location module 208 of the mobile computing device 202 can provide the location information to the computer system 204. The location information may be provided based on prior user consent (e.g., consent to a user license agreement), but may not be provided in response to direct user input. For example, a background process may run on the mobile computing device 202 and periodically provide the location information to the system 204 without being specifically prompted to (not in response to) input from a user of the mobile computing device 202.

A notification can be received with a suggested order for an item from a nearby provider (406). For example, the messaging subsystem 210 of the mobile computing device 202 can receive a notification from the computer system 204. The notification can be received without the mobile computing device 202 having received user input specifically requesting the notification or the suggested order. The notification can be output by the mobile computing device (408). For example, the order application 212 can use one or more components of the output subsystem 216 to output the notification for the suggested order, as depicted, for example, in FIG. 1A.

User input can be received selecting a feature to place the suggested order (410), in response to which a request for the order can be provided to the computer system (412). For example, input can be received on the mobile computing device 202 through the input subsystem 214, in response to which the order application 212 can provide a request for the order to the computer system 204.

Another notification indicating ae status of the order can be received (414) and output on the mobile computing device (416). For example, the messaging subsystem 210 can receive another notification from the computer system 204 indicating the status of the order (e.g., in process, fulfilled, ready for pickup) and can be output to the user using the output subsystem 216.

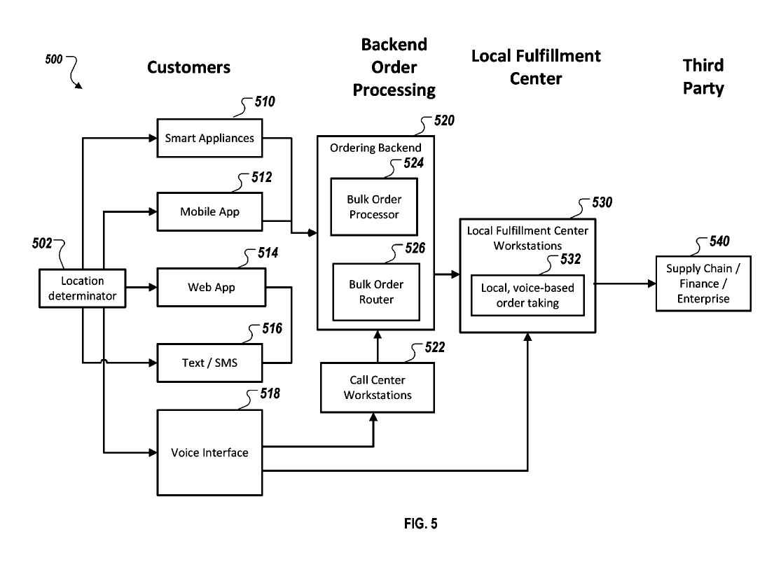

FIG. 5 is a block diagram of an example system 500. Briefly, and as described in further detail below, the system 500 may include a location determinator 502, smart appliances 510, a mobile application 512, a web application 514, a text or short message service (SMS) application 516, a voice interface 518, an ordering backend 520, call center workstations 522, local fulfillment center workstations 530, and a supply chain, finance, or enterprise component 540. The system 500 may provide for real time delivery of an item. Real time delivery may include point-to-point delivery of small, tangible, purchased goods within a very short period of time of purchase, e.g., few minutes to a few hours. Purchased goods may include typical packaged goods that do not otherwise require real-time delivery, e.g., consumer electronics or office supplies, goods that degrade over a long period of time, e.g., groceries or flowers, or goods that degrade within a very short period of time, e.g., dry ice, ice cream, hot pizza or a cup of coffee.

The location determinator 502 may determine location information for a customer. For example, the location determinator 502 may determine a customer's location based on or more of a service set identifier (SSID) of a nearby detected wireless network, a detected phone mast signal, determined global positioning system (GPS) information, an assigned Internet Protocol (IP) address, a landline location, or a wireless media access control (MAC) address. The location determinator 502 may provide the location information to the smart appliances 510, the mobile application 512, the web application 514, the text or short message service (SMS) application 516, and the voice interface 518.

The smart appliances 510, the mobile application 512, the web application 514, the text or short message service (SMS) application 516, and the voice interface 518 may enable a customer to place an order. For example, one or more of the smart appliances 510, the mobile application 512, the web application 514, the text or short message service (SMS) application 516, and the voice interface 518 may enable a customer to place an order for a cheese pizza to be delivered to the customer's home address at 6:00 PM. To enable customers to place orders, the smart appliances 510, the mobile application 512, the web application 514, the text or short message service (SMS) application 516, and the voice interface 518 may provide interfaces through which the customer may specify a particular item to order, and a particular location for which the customer would like to obtain the item. For example, the smart appliances 510, the mobile application 512, the web application 514, the text or short message service (SMS) application 516, and the voice interface 518 may visually or audibly provide prompts to the customer requesting that the customer specify a particular item to order, a particular location to receive the item, and a particular time to receive the item.

More specifically, the smart appliances 510 may be appliances that may be used to place orders. For example, the smart appliances 510 may include a television that may be used by a customer to place an order for a pizza. The smart appliances 510 may provide an interface for a customer to place an order. For example, the smart appliance 510 may include a display that may render an interface for the customer to order a pizza. The smart appliances 510 may provide orders to an ordering backend 520. For example, the smart appliances 510 may provide an order for a pizza through a network to the ordering backend 520.

The mobile application 512 may be an application running on a mobile device that enables a customer to place an order. For example, an application running on a customer's smart phone may enable the customer to place an order for pizza. A mobile device may include a smart phone, a tablet computer, or some other type of computing device that may be portably used. The mobile application 512 may provide an interface for a customer to place an order. For example, the mobile application 512 may display on the mobile device an interface for the customer to order a pizza. The mobile application 512 may provide orders to an ordering backend 520. For example, the mobile application 512 may provide an order for a pizza through a network to the ordering backend 520.

The web application 514 may be an application accessible through a web browser running on a computing device, where the application enables a customer to place an order. For example, a Java application may be rendered by a web browser on a desktop computer and enable a customer to place an order for pizza. A computing device may include a mobile device, a desktop computer, a laptop computer, or some other type of device that computes. The web application 514 may provide an interface for a customer to place an order. For example, the web application 514 may display an interface, in a web browser on a desktop computer, for the customer to order a pizza. The web application 514 may provide orders to an ordering backend 520. For example, the web application 514 may provide an order for a pizza through a network to the ordering backend 520.

The text or SMS application 516 may be an application running on a mobile device that enables a customer to place an order by text or SMS. For example, an application running on a customer's smart phone may enable the customer to send a text or SMS message to the ordering backend 520 to place an order for pizza. In some implementations, the application may provide a graphical user interface for the user to select a particular item, particular location, and a particular time to receive the item, and generate a SMS message indicating the selections and provide the SMS message to the ordering backend 520.

The voice interface 518 may be an interface that enables a customer to place an order by voice. For example, the voice interface 518 may be a telephone that a customer may use to verbally order a pizza. The voice interface 518 may communicate with the call center workstations 522. For example, the voice interface 518 may transmit audio captured by the voice interface 518 to the call center workstations 522, and similarly, output audio from the call center workstations 522. The voice interface 518 may additionally or alternatively communicate with a local voice-based order taking component 532 of a local fulfillment center workstation 530. For example, the voice interface 518 may transmit audio captured by the voice interface 518 to the local voice-based order taking component 532, and similarly, output received audio from the local voice-based order taking component 532.

The call center workstations 522 may receive voice input from the voice interface 518, generate orders based on the voice input, and provide the orders to the ordering backend 520. For example, the call center workstations 522 may audibly output voice input from the interface 518 to allow customer service representatives to verbally interact with customers, and generate orders for the customers. In some implementations, the call center workstations 522 may be automated and use speech recognition to generate orders for users. For example, the call center workstations 522 may execute an Artificial Intelligence customer service agent program that may verbally speak to the customer to take the order and place the order directly for the customer.

The ordering backend 520 may be a component that processes orders from customers. For example, the ordering backend may receive orders from the smart appliances 510, mobile application 512, web application 514, text or SMS application 516, the voice interface 518, or the call center workstations 522. The ordering backend 520 may process orders based on determining, for each order, one or more local fulfillment center workstations 530 to receive the order. For example, the ordering backend 520 may determine that a first order for a pizza should be provided to a first local fulfillment center workstation and a second order for a pizza should be provided to a different, second local fulfillment center workstation.

The ordering backend 520 may determine a local fulfillment center workstation to receive a particular order based on a location which the customer would like to obtain the item ordered. For example, the ordering backend 520 may determine that a first order indicates the order is to be obtained at a location where the distance from the location to the local fulfillment center is within a distance threshold, and in response, determine to provide the first order to a workstation of the local fulfillment center. In another example, the ordering backend 520 may determine that a second order is to be obtained at a location where the distance from the location to the local fulfillment center exceeds a distance threshold, and in response, determine the second order should be provided to a workstation of another local fulfillment center.

Additionally or alternatively, the ordering backend 520 may determine a local fulfillment center workstation to receive a particular order based on availability of the local fulfillment center to fulfill the order. For example, the ordering backend 520 may determine that a first order for a pizza can be fulfilled by a local fulfillment center as the local fulfillment center may still have capacity to provide the pizza. In another example, the ordering backend 520 may determine that a second order for a pizza cannot be fulfilled by a local fulfillment center as the local fulfillment center may not have capacity to provide the pizza.

In response to determining the local fulfillment center workstations 530 to receive an order, the ordering backend 520 may provide the order to the local fulfillment center workstations 530. For example, in response to determining that a local fulfillment center does deliver to the particular location requested by a customer and has capacity to fulfill an order for pizza, the ordering backend 520 may determine to provide the order for pizza to the local fulfillment center workstations 530 of the local fulfillment center.

In processing the orders, the ordering backend may also process payments for the orders. For example, the ordering backend 520 may validate whether payment information provided in the order is correct. In another example, the ordering backend 520 may place charges for orders using payment information provided in the order.

The ordering backend 520 may include a bulk order processor 524. The bulk order processor 524 may enable the ordering backend 520 to perform mass processing of orders. For example, the ordering backend 520 may receive an extremely large number of orders within a given time frame from the smart appliances 510, mobile application 512, web application 514, text or SMS application 516, the voice interface 518, or the call center workstations 522. Processing such an amount of orders may include determining, for each order, one or more local fulfillment center workstations out of thousands of potential local fulfillment center workstations 530 to receive the order.

The ordering backend 520 may also include a bulk order router 526. The bulk order router 526 may enable the ordering backend 520 to perform mass management of logistics, including delivery scheduling and collection scheduling of received orders. For example, the ordering backend may receive an extremely large number of orders within a given time frame from the smart appliances 510, mobile application 512, web application 514, text or SMS application 516, the voice interface 518, or the call center workstations 522. Managing the delivery scheduling or collection scheduling of such an amount of orders may include determining an order preparation schedule for each local fulfillment center workstation.

The ordering backend 520 performs a variety of tasks relating to processing or routing bulk orders, including sorting, assigning, routing, queuing, distributing and scheduling, to name a few. The study, optimization and execution of these tasks requires the uses of techniques and results from well-developed, active areas of scientific research, such as operational research, combinatorial optimization, graph theory (in particular network theory), queuing theory, and transport theory. Executing or providing optimal solutions to such tasks are proven to be complex and mathematically hard, particularly when considering large-scale systems. For example, e-commerce giant Amazon reported that they received, processed and delivered orders for 426 items per second in the run up to Christmas in 2013, see for example http://articles.latimes.com/2013/dec/26/business/la-fi-tn-amazon-sold-426-items-per-second-cyber-monday-20131226.

Since scaling is an extremely important factor, particularly in the context of e-commerce, tasks relating to processing or routing bulk orders quickly become extremely difficult, if not impossible, to solve and require powerful computers implementing complex algorithms and elegant mathematical programming techniques, as well as robust hardware architectures that can be parallelized. In some cases, it has even been shown that many tasks relating to the processing or routing of bulk orders are computationally intractable. In fact, the theory of computational complexity has introduced a concept of NP-hardness to classify such computationally intractable tasks.

For example, consider the intensely studied Traveling Salesman Problem (TSP), an NP-hard problem in combinatorial optimization. In its purest formulation, the TSP may be described as follows: given a list of cities and the distances between each pair of cities, what is the shortest route that visits each city exactly once, and returns to the original city. The TSP may also be modeled and described as a graph problem, wherein the cities are the graph's vertices and the distances between each pair of cities are the lengths of the graph's edges, or formulated as an integer linear program. The TSP has several applications in operational research, including planning and logistics, wherein the concept of a city may represent customers or orders, and the concept of a distance may represent travelling times or incurred costs. In some implementations, additional constraints may be imposed on the TSP, such as limiting an amount of resources or limiting to certain time windows. Finding increasingly efficient solutions to the TSP and other such complex, subtle operational research problems is an active area of scientific research, as evidenced by a plethora of technical textbooks, journals and scientific articles. See, for example “In Pursuit of the Travelling Salesman: Mathematics at the Limits of Computation,” William Cook, Princeton University Press, 2011, “Dynamic programming strategies and reduction techniques for the traveling salesman problem with time windows and precedence constraints,” L. Bianco, A. Mingozzi, and S. Ricciardelli, Operations Research, 45 (1997) 365-377 and “Scheduling vehicles from a central depot to a number of delivery points,” G. Clarke and J. Wright, Operations Research 52 (1964) 568-581.

Another well-studied, fundamental combinatorial optimization problem in the field of operational research and optimization is the Assignment Problem (AP). In its most general form, the AP may be described as follows: given a number of agents, a number of tasks and a set of incurring costs for each potential agent-task assignment, perform all tasks by assigning one agent to each task, and one task to each agent, such that the total costs incurred is minimized. The AP also has several applications in areas such as planning and logistics. For example, the ordering backend 520 may interpret the task of processing received orders as an assignment problem, wherein a local fulfillment center workstation can be assigned to deliver an order, incurring some cost. The bulk order processor 524, for example, may require that all orders are delivered by assigning one local fulfillment center to each order, and one order to each local fulfillment center, in such a way that the total cost of the assignment is minimized. It has been shown that such an assignment problem can be expressed mathematically as a standard linear program, see, for example “Algorithms for the Assignment and Transportation Problems,” James Munkres, Journal of the Society for Industrial and Applied Mathematics Vol. 5, No. 5 (March, 5957), pp. 32-38.

Linear programming has been shown to be an extremely powerful, essential optimization technique widely applied in various fields of study such as business studies and economics, as well as industrial areas such as engineering, transportation and manufacturing. The sophisticated mathematical programming techniques used in linear programming have proven essential to the modeling of diverse types of problems in routing, scheduling and assignment, and in turn have led to the creation of powerful computer systems that enable businesses to reduce costs, improve profitability, use resources effectively, reduce risks and provide untold benefits in many other key dimensions. Mathematically, linear programming is a technique for the optimization of a linear objective function, subject to linear equality and linear inequality constraints. While this requirement may seem overly restrictive, many real-world business problems can be formulated in this manner. Today, commercial linear-programming codes are able to solve linear programs with millions of constraints. For example, the commercial, high-performance mathematical programming solver IBM ILOG CPLEX of IBM is able to solve linear programs with the number of megabytes required for computation approximately equal to the number of constraints divided by 5000, see http://www-01.ibm.com/support/docview.wss?uid=swg21399933.

When dealing with large-scale systems, system components, such as the ordering backend 520, may employ techniques and results from Queuing Theory—the mathematical study of waiting lines, or queues—in order to model incoming customers or orders and subsequently make business decisions relating to order fulfillment, resource requirements for providing a certain service, expected waiting time in a queue, average time in a queue, expected queue length, expected number of customers in a queue at a given time, and the probability of a system to be in a certain state, such as empty or full. For example, it has been shown that most queues in restaurant operations can be described by an M/M/1 queue, where arrivals are determined by a Poisson process with heavy periods around lunch and dinner time, and service times have an exponential distribution. In a complex system of multiple M/M/1 queues, or a queue network, deep and sophisticated mathematical techniques such as stochastic calculus may be employed to model or approximate the queuing process. For example, in some implementations a heavy traffic approximation may be used to approximate a queuing process by a reflected Brownian motion, Ornstein-Uhlenbeck process or more general diffusion process. Since queues are basic components to both external and internal business processes, including scheduling and inventory management, understanding the nature of queues and learning how to manage them is one of the most important areas in operational research and management. See, for example, “A Methodology and Implementation for Analytic Modeling in Electronic Commerce Applications,” H. Edwards, M. Bauer, H. Luthyya, Y. Chan, M. Shields and P. Woo, Electronic Commerce Technologies, Lecture notes in computer science, Volume 2040, 2001, pp 548-157 and “Stochastic Models in Queuing Theory”, J. Medhi, Elsevier Academic Press, 2002.

The local fulfillment center workstations 530 may receive orders from the ordering backend 520. For example, a particular local fulfillment center workstation may receive an order for pizza from the ordering backend 520. The local fulfillment center workstations may be located on the premises of the local fulfillment center and used by agents of the local fulfillment center. For example, a local fulfillment center workstation of a pizza provider may be located in a kitchen of the pizza provider and used by bakers to determine what pizzas to bake and when to bake the pizzas. In another example, local fulfillment center workstations of a pizza provider may be located in delivery vehicles of the pizza provider and used by pizza deliverers to determine where to deliver each pizza or a delivery route for the pizzas. The delivery route may be dynamically planned based on types of orders and locations to which the orders will be delivered. In yet another example, a local fulfillment center workstation may be used by a cashier of a pizza provider and used by the cashier to place additional orders for customers within the restaurant or determine whether a customer is the correct customer to receive a pizza that is ordered for pickup at the restaurant.

The local fulfillment center workstations 530 may provide information to agents of the local fulfillment center to fulfill orders. For example, a particular local fulfillment center workstation of a pizza provider may display an order number, a type of pizza ordered, a customer name for the order, a place of delivery for the order, and a time of delivery for the order. The local fulfillment center workstations 530 may obtain the information to provide agents of the local fulfillment center from the orders received from the ordering backend 520. For example, the orders received from the ordering backend 520 may include data that indicates an order number, a type of pizza ordered, a customer name for the order, a place of delivery for the order, and a time of delivery for the order. In some implementations, the local fulfillment center workstations 530 may prioritize the fulfillment of orders. For example, the local fulfillment center workstations 530 may prioritize the fulfillment of orders based on when the orders are to be provided to the users.

The local fulfillment center workstations 530 may include a local, voice-based order taking component 532. For example, the local fulfillment center workstations 530 may include a telephone-based system with which an employee of the local fulfillment center may speak to the customer. The local, voice-based order taking component 532 may enable customers to place orders directly with the local fulfillment center. For example, the same local fulfillment center workstations 530 that receive orders from the ordering backend 520 may also be used to generate orders based on input from customer service agents using the local fulfillment center workstations 530. In some implementations, the local, voice-based order taking component 532 may be automated and use speech recognition to generate orders for users.

The local fulfillment center workstations 530 may additionally or alternatively communicate with a supply chain or finance or enterprise component of a third party. For example, a local fulfillment center workstation may place an order for more flour with a supply chain component of a third party that sells flour for pizza. In another example, a local fulfillment center workstation may communicate with a finance component to place payment charges for orders.

The local fulfillment center workstations 530 may automatically determine to communicate with the supply chain or finance or enterprise component. For example, the local fulfillment center workstations 530 may automatically determine that the amount of flour in the inventory of the local fulfillment center is below a flour threshold, and in response, place an order for flour to the supply chain component of a pizza flour provider.

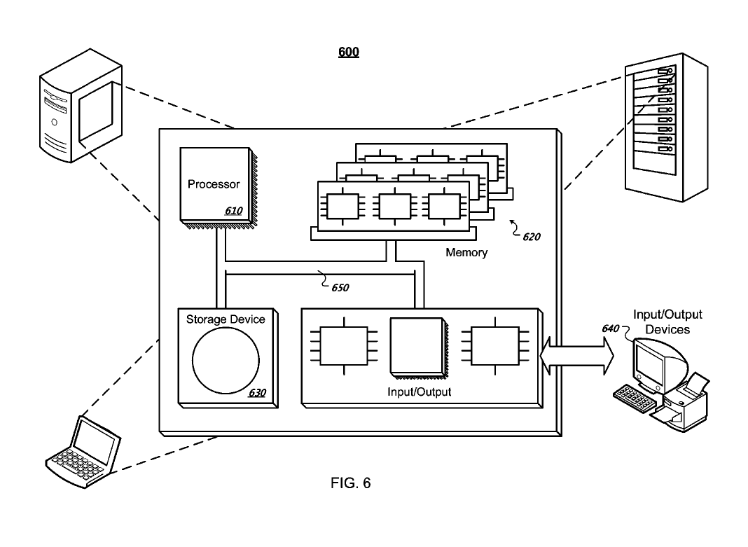

FIG. 6 illustrates a schematic diagram of an exemplary generic computer system. The system 600 can be used for the operations described in association with the processes 300 according to some implementations. The system 600 may be included in the system 500.

The system 600 includes a processor 610, a memory 620, a storage device 630, and an input/output device 640. Each of the components 610, 620, 630, and 620 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A computer-implemented method comprising:
receiving, at a computer system, location information that identifies, at least, a current location of a mobile computing device that is associated with a user;
accessing, by the computer system, order history information for the user, wherein the order history information identifies, at least, (i) previous food orders that were placed by the user, (ii) providers that fulfilled the previous orders, and (iii) items that were included in the previous orders;
identifying, by the computer system, candidate providers based on the current location of the mobile computing device;
determining, by the computer system, one or more confidence values that indicate extents to which the user is likely to be interested in ordering one or more of food items from one or more of the candidate providers, the one or more confidence values being determined based, at least in part, on (i) the current location of the mobile computing device, (ii) the order history information, and (iii) the candidate providers;
selecting, by the computer system, a food suggestion for a particular food item to be fulfilled by a particular candidate provider and provided to the user based, at least in part, on the one or more confidence values, wherein the particular food item is selected from among the one or more food items and the particular candidate provider is selected from among the one or more candidate providers, the particular food item being one of a plurality of food items provided by the particular candidate provider; and
providing, by the computer system and to the mobile computing device, a notification of the food suggestion that suggests the user place an order for the particular food item with the particular candidate provider.

2. The computer-implemented method of claim 1, further comprising:
receiving, at the computer system and from the mobile computing device, a request to place the order with the particular candidate provider in response to the notification; and
initiating, by the computer system, fulfillment of the order by the particular candidate provider, wherein the initiating causes the order to be provided to the particular candidate provider.

3. The computer-implemented method of claim 2, further comprising:
providing, by the computer system and to the mobile computing device, another notification confirming that the order has been received and is being fulfilled by the particular candidate provider.

4. The computer-implemented method of claim 2, further comprising:
receiving, at the computer system, information indicating that the order has been fulfilled and is available for pickup at the particular candidate provider; and
providing, by the computer system and to the mobile computing device, another notification indicating that the order has been fulfilled and is available for pickup at the particular candidate provider.

5. The computer-implemented method of claim 1, wherein the location information further identifies a route along which the mobile computing device is travelling,
the method further comprising:
determining, by the computer system, a destination location to which the mobile computing device is likely travelling based, at least in part, on the current location of the mobile computing device and the route,
wherein the candidate providers are additionally identified as being located within a threshold distance of either the destination location or points along portions of the route that have not yet been reached by the mobile computing device.

6. The computer-implemented method of claim 1, wherein:
the location information further identifies a current elevation of the mobile computing device, and
the candidate providers are identified as being within a threshold distance of the mobile computing device at the current elevation and the current location.

7. The computer-implemented method of claim 1, further comprising:
determining, by the computer system, a current time of day,
wherein:
the order history information further identifies previous times at which the previous orders that were placed by the user, and
the one or more confidence values are determined further based on a comparison of the current time of day and the previous times.

8. The computer-implemented method of claim 7, further comprising:
accessing, by the computer system, preference information that identifies one or more preferences for the user;
wherein:
the order history information further includes information that identifies whether the previous food orders are included in the one or more preferences, and
the one or more confidence values are determined further based on a comparison of the preference information and the previous food orders.

9. The computer-implemented method of claim 1, further comprising:
identifying, by the computer system, one or more current external factors for the user,
wherein:
the order history information further identifies previous external factors when the previous orders that were placed by the user, and
the one or more confidence values are determined further based on a comparison of the current external factors and the previous external factors.

10. The computer-implemented method of claim 9, wherein the current external factors and the previous external factors include one or more of: weather, traffic, the user's schedule, and the user's activity level as indicated by data collected from one or more activity tracking devices.

11. The computer-implemented method of claim 1, further comprising:
identifying, by the computer system, a current speed at which the mobile computing device is travelling,
wherein the candidate providers are further identified based on the current speed.

12. The computer-implemented method of claim 1, wherein the particular candidate provider is one of the providers that fulfilled the previous orders.

13. The computer-implemented method of claim 1, wherein the particular candidate provider is different from each of the providers that fulfilled the previous orders.

14. The computer-implemented method of claim 13, wherein the particular candidate provider is part of a chain of providers, and one or more other providers that are also part of the chain of providers are included in the providers that fulfilled the previous orders.

15. The computer-implemented method of claim 1, wherein the order history information for the user further identifies previous orders that the user placed but did not pick up.

16. The computer-implemented method of claim 1, wherein the order history information for the user further identifies:
previously declined order suggestions that included notifications with order suggestions sent to the mobile computing device and declined by the user, and
previously accepted order suggestions that included notifications with order suggestions sent to the mobile computing device and accepted by the user.

17. The computer-implemented method of claim 1, wherein the notification comprises a push notification.

18-20. (canceled)

21. The computer-implemented method of claim 1, further comprising:
providing, by the computer system and to the mobile computing device, an order application for installation on the mobile computing device;
formatting, by the computer system, the notification in a format used by the order application, the notification being formatted to additionally include an identifier for the particular provider;
wherein the notification activates the order application to cause display of the notification on the mobile computing device and to enable connection via the identifier to a provider computer system over one or more networks when the mobile computing device connects to the computer system in response to the notification being selected on the mobile computing device.

22. The computer-implemented method of claim 21, wherein installation of the order application on the mobile computing device causes the order application to automatically transmit the current location of the mobile computing device to the computer system at periodic intervals of time when the mobile computing device is connected to the Internet, the automatically transmitting being performed by the order application without user input.

23. The computer-implemented method of claim 21, wherein the notification being selected on the mobile computing device comprises a selectable feature for placing the order for the particular food item with the particular candidate provider displayed by the order application being selected by the user.
